(19) United States
(12) Patent Application Publication
(10) Pub. No.: US 2011/0242099 A1
(43) Pub. Date: Oct. 6, 2011

(54) IMAGE PROCESSING APPARATUS, IMAGE PROCESSING METHOD, AND PROGRAM

(75) Inventors: Takuya ARAI, Kanagawa (JP); Yasuhito Shikata, Tokyo (JP); Kimu Higashimoto, Tokyo (JP)

(73) Assignee: Sony Corporation, Tokyo (JP)

(21) Appl. No.: 13/069,045

(22) Filed: Mar. 22, 2011

(30) Foreign Application Priority Data
Mar. 30, 2010 (JP) P2010-077985

(51) Int. Cl. G06T 15/00; G06T 1/00

(52) U.S. Cl. 345/419; 345/418

(57) ABSTRACT

An image processing apparatus includes a reproduction control unit inputting single viewpoint images and multi viewpoint images and generating output data to be output to a display unit. In a case where the display unit performs display in a multi viewpoint image display mode, the reproduction control unit generates and outputs the output data in which each viewpoint image forming the multi viewpoint image is developed at a development position of each viewpoint image defined according to a multi viewpoint image transmission format when outputting the multi viewpoint images. The reproduction control unit generates and outputs the output data in which the same single viewpoint image is developed at the development position of each viewpoint image defined according to the multi viewpoint image transmission format when outputting the single viewpoint images.

### BACKGROUND OF THE INVENTION

1. Field of the Invention

The present invention relates to an image processing apparatus, an image processing method, and a program, and more particularly, to an image processing apparatus, an image processing method, and a program capable of displaying multi viewpoint images such as 3-dimensional images (3D images) and single viewpoint images such as 2-dimensional images (2D images).

2. Description of the Related Art

In recent years, a display apparatus such as a television capable of reproducing multi viewpoint images such as 3-dimensional images or a camera or the like capable of recording multi viewpoint images such as 3-dimensional images rapidly has come into wide use.

For example, the camera capable of recording the multi viewpoint images such as 3-dimensional images has a configuration in which a photographing/recording process of 3-dimensional images and 2-dimensional images can be performed by mode conversion. The images photographed in a 3-dimensional image photographing mode are recorded according to a predetermined 3-dimensional image file format such as an MPO (Multi-Picture Format) format. The images photographed in a 2-dimensional image (2D image) photographing mode are recorded according to a predetermined 2-dimensional image file format such as a JPEG (Joint Photographic Coding Experts Group) format.

A file containing the photographed images is recorded according to, for example, a DCF (Design rule for Camera File system) which is a standard of a method of recording the photographing data of a camera. In this recording process, a folder where a 3D image content file and a 2D image content file coexist can be set. A reproduction sequence for reproducing the recorded data can be set in various methods. For example, various image files in a folder can be reproduced collectively, or folders or files selected in each event each day are sequentially reproduced. That is, the reproduction can be performed by a unit associated with any format.

A related art disclosing a method of converting display using control information used to determine whether display images are 2D images or 3D images includes Japanese Unexamined Patent Application Publication No. 2008-42645.

When the 3D images and the 2D images coexist in the reproduction content and it is necessary to convert and display the 3D images and the 2D images, it takes some time to perform the conversion process. In particular, when the content is analyzed to determine whether images are the 3D images or the 2D images and to convert the display process form, it is necessary to analyze the images and thus it takes a lot of time to perform the conversion. In this case, the reproduction of the images is temporarily stopped. When it is necessary for a user to wear and take off a device, such as shutter-type glasses, for viewing 3D images, the user has to wear or take off the glasses whenever the images are converted. Therefore, conversion time or burden on the user occurs when the 3D images and the 2D images are converted and displayed.

In order to prevent the processing time or the burden on the user caused due to the conversion of the images, for example, a method of not reproducing images in which single viewpoint images such as 2D images and multi viewpoint images such as 3D images coexist can be taken into consideration. Alternatively, it is considered that a process of displaying all of the images according to a method of reproducing only either one of the 2D images and the 3D images in the reproduction can also be effective. However, a method of forcibly displaying all of the 3D images as the 2D images does not satisfy the original purpose to display the 3D images.

A method of processing and displaying single viewpoint images such as 2D images to stereoscopically view the single viewpoint images can be implemented technically in a pseudo way in order to display all images as the 3D images. For example, Japanese Unexamined Patent Application Publication No. 2008-244835 discloses a display control method using the data conversion. However, this data conversion is just a pseudo conversion method and it is sometimes difficult to convert the 2D images into the 3D images so that a user may not feel an appropriately natural stereoscopic sense. Moreover, in practice, it is difficult to perform this conversion for all display apparatuses.

Japanese Unexamined Patent Application Publication No. 2002-199416 discloses a configuration in which a display apparatus is divided into division areas and a 3D image or a 2D image is displayed in each division area in order to display a mixed image of the 3D image and the 2D image.

However, such a display apparatus is not typical and there is a problem that costs may increase due to the special configuration which is necessary.

### SUMMARY OF THE INVENTION

It is desirable to provide an image processing apparatus, an image processing method, and a program capable of preventing a conversion processing time from being extended in a configuration in which multi viewpoints such as 3-dimensional images (3D images) and single viewpoint images such as 2-dimensional images (2D images) are converted and displayed smoothly, and capable of implementing smooth image conversion display in a configuration in which it is not necessary for a user to wear and take off a pair of glasses.

According to an embodiment of the invention, there is provided an image processing apparatus including a reproduction control unit inputting single viewpoint images and multi viewpoint images and generating output data to be output to a display unit. In a case where the display unit performs display in a multi viewpoint image display mode, the reproduction control unit generates and outputs the output data in which each viewpoint image forming the multi viewpoint image is developed at a development position of each viewpoint image defined according to a multi viewpoint image transmission format when outputting the multi viewpoint images. The reproduction control unit generates and outputs the output data in which the same single viewpoint image is developed at the development position of each viewpoint image defined according to the multi viewpoint image transmission format when outputting the single viewpoint images.

In the image processing apparatus according to the embodiment of the invention, in a case where the display unit performs display in a 3-dimensional image display mode, the reproduction control unit may generate and output the output data in which the left and right viewpoint images are respectively developed at image development positions corresponding to left and right viewpoints defined according to the 3-dimensional image transmission format when outputting the 3-dimensional images. The reproduction control unit may generate and output the output data in which the same 2-dimensional image is developed at the image development positions corresponding to left and right viewpoints defined according to the 3-dimensional image transmission format when outputting the 2-dimensional images.

In the image processing apparatus according to the embodiment of the invention, in a case where the 3-dimensional image transmission format is a side-by-side method, the reproduction control unit may generate and output the output data in which images corresponding to left and right viewpoints are respectively developed at left and right positions in one frame image when outputting the 3-dimensional images. The reproduction control unit may generate and output the output data in which the same 2-dimensional image is developed at the left and right positions in one frame image when outputting the 2-dimensional images.

In the image processing apparatus according to the embodiment of the invention, in a case where the 3-dimensional image transmission format is an over-and-under method, the reproduction control unit may generate and output the output data in which images corresponding to left and right viewpoints are respectively developed at upper and lower positions in one frame image when outputting the 3-dimensional images. The reproduction control unit may generate and output the output data in which the same 2-dimensional image is developed at the upper and lower positions in one frame image when outputting the 2-dimensional images.

In the image processing apparatus according to the embodiment of the invention, in a case where the 3-dimensional image transmission format is a frame sequential method, the reproduction control unit may generate and output the output data in which images corresponding to left and right viewpoints are alternately developed for each frame, when outputting the 3-dimensional images. The reproduction control unit may generate and output the output data in which the same 2-dimensional image is developed for each two successive frames when outputting the 2-dimensional images.

In the image processing apparatus according to the embodiment of the invention, the reproduction control unit may perform a process of determining whether an input image is the single viewpoint image or the multi viewpoint image through analysis based on an extension of each image file.

In the image processing apparatus according to the embodiment of the invention, in a case where an N-viewpoint image is asked from the display unit, when the obtainable multi viewpoint image is an image of viewpoints less than N, the reproduction control unit may copy a partial image of the image with the viewpoints less than N and output the image as the N-viewpoint image.

According to another embodiment of the invention, there is provided an image processing method of performing image output control by an image processing apparatus, the image processing method including the step of generating output data to be output to a display unit by inputting single viewpoint images and multi viewpoint images by a reproduction control unit. In a case where the display unit performs display in a multi viewpoint image display mode, the step of generating the output data executes a process of generating and outputting the output data in which each viewpoint image forming the multi viewpoint image is developed at a development position of each viewpoint image defined according to a multi viewpoint image transmission format when the multi viewpoint images are output. The step of generating the output data executes a process of generating and outputting the output data in which the same single viewpoint image is developed at the development position of each viewpoint image defined according to the multi viewpoint image transmission format when the single viewpoint images are output.

According to still another embodiment of the invention, there is provided a program causing an image processing apparatus to execute image output control, the program including the step of generating output data to be output to a display unit by inputting single viewpoint images and multi viewpoint images by a reproduction control unit. In a case where the display unit performs display in a multi viewpoint image display mode, the step of generating the output data executes a process of generating and outputting the output data in which each viewpoint image forming the multi viewpoint image is developed at a development position of each viewpoint image defined according to a multi viewpoint image transmission format when the multi viewpoint images are output. The step of generating the output data executes a process of generating and outputting the output data in which the same single viewpoint image is developed at the development position of each viewpoint image defined according to the multi viewpoint image transmission format when the single viewpoint images are output.

The program according to the embodiment of the invention is a program which can be provided to, for example, an information processing apparatus or a computer system capable of executing various program codes from a recording medium or a communication medium provided in a computer readable format. By providing the program in the computer readable format, the processes are executed in accordance with the program on the information processing apparatus or the computer system.

The other goals, features, and advantages of the embodiments of the invention are clarified in the detailed description based on the embodiments of the invention and the accompanying drawings described below. The system in the specification has a logical collective configuration of a plurality of apparatuses and is not limited to a case where the apparatuses with each configuration are included in the same chassis.

According to the embodiments of the invention, the multi viewpoint images and the single viewpoint images can be displayed without performing the conversion process of the display between the multi viewpoint images and the single viewpoint images in the display unit. In the case where the display unit performs the display in the multi viewpoint image display mode, the output data in which each viewpoint image forming the multi viewpoint image is developed at the development position of each viewpoint image defined according to the multi viewpoint image transmission format is generated and output to the display control unit, when the multi viewpoint images such as the 3-dimensional images are output. The output data in which the same single viewpoint image is developed at the development position of each viewpoint image defined according to the multi viewpoint image transmission format is generated and output to the display control unit, when the single viewpoint images such as the 2-dimensional images are output. By the above processes, the multi viewpoint images and the single viewpoint images can smoothly be converted and displayed without performing the conversion process in the display unit.

### BRIEF DESCRIPTION OF THE DRAWINGS

FIG. 1 is a diagram illustrating an exemplary configuration of an image processing apparatus according to an embodiment of the invention.

FIG. 2 is a diagram illustrating an exemplary structure of data stored in a storage unit.

FIGS. 3A and 3B are diagrams illustrating the exemplary structure of the data stored in the storage unit.

FIG. 4 is a diagram illustrating exemplary processing of a reproduction control unit when multi viewpoint images are displayed.

FIG. 5 is a diagram illustrating exemplary processing of a reproduction control unit when single viewpoint images are displayed.

FIG. 6 is a flowchart illustrating a processing sequence performed in the image processing apparatus according to the embodiment of the invention.

### DESCRIPTION OF THE PREFERRED EMBODIMENTS

Hereinafter, an image processing apparatus, an image processing method, and a program according to an embodiment of the invention will be described in detail with reference to the drawings. The description will be made according to the following items.

1. Exemplary Configuration of Image Processing Apparatus

2. Exemplary Structure of Recorded Data

3. Image Reproducing Process

4. Display Control Sequence of Image Processing Apparatus according to Embodiment of the Invention

5. Modified Examples

### 1. EXEMPLARY CONFIGURATION OF IMAGE PROCESSING APPARATUS

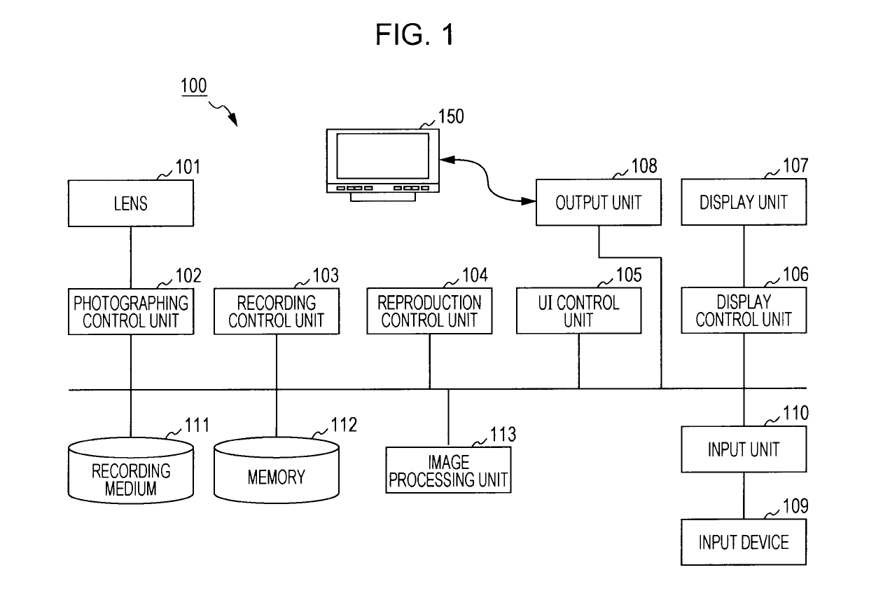

An exemplary configuration of an image processing apparatus according to an embodiment of the invention will be described with reference to FIG. 1. An example of an imaging apparatus which is an example of the image processing apparatus will be described according to the embodiment described below. Here, the image processing apparatus according to the embodiment of the invention may be an apparatus capable of outputting images to a display unit of the subject apparatus or an external display apparatus connected via an output unit. The image processing apparatus according to the embodiment of the invention is not limited to the imaging apparatus, but may include various apparatuses such as a PC, a TV, and a media player. Hereinafter, an example of the imaging apparatus which is an example of the image processing apparatus according to the embodiment of the invention will be described.

FIG. 1 is a block diagram illustrating the configuration of an imaging apparatus 100 which is an example of the image processing apparatus according to the embodiment of the invention.

As shown in FIG. 1, the imaging apparatus 100 includes a lens 101, a photographing control unit 102, a recording control unit 103, a reproduction control unit 104, a UI (User Interface) control unit 105, a display control unit 106, a display unit 107, an output unit 108, an input device 109, an input unit 110, a recording medium 111, a memory 112, and an image processing unit 113.

Operation information of a user is input to the input unit 110 through the input device 109. The UI control unit 105 analyzes input information of the input unit 110 and execution of an intended function of the user in a menu or the like displayed on the display unit 107, and a process starts according to the analysis. For example, the kinds of processes are broadly classified into a photographing recording process, a reproduction process, and the like. Detailed processes include various processes such as a mode setting process, a photographing start process, and a photographing end process of photographing recording process.

When the photographing process is performed, an image photographed through the lens 101 under the control of the photographing control unit 102 is temporarily stored in the memory 112, and then is supplied to the recording control unit 103 to perform a process of recording the image in the recording medium 111 under the control of the recording control unit 103. When the image recording process is performed, the image processing unit 113 performs encoding on the image according to a predetermined format.

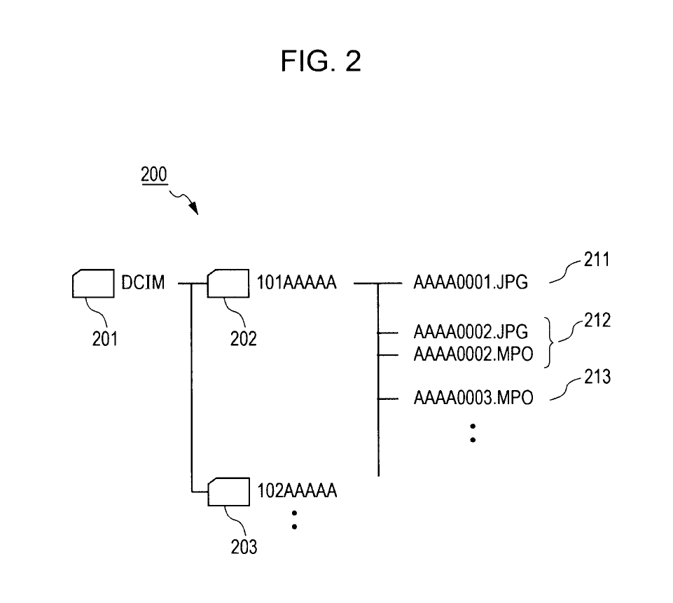

For example, when the photographed image is a multi viewpoint image such as 3-dimensional image, the image is recorded in an MPO (Multi-Picture Format). When the photographed image is a single viewpoint image such as a 2-dimensional image, the image is recorded in a JPEG (Joint Photographic Coding Experts Group) format. The recording process of recording the image in the recording medium 111 is performed according to, for example, a DCF (Design rule for Camera File system) which is a standard of the recording method of the photographed data of a camera. An exemplary configuration of the recorded data according to the DCF standard will be described in detail below with reference to FIG. 2.

When the data recorded in the recording medium 111 is reproduced, the data is acquired from the recording medium 111 under the control of the reproduction control unit 104. The acquired data is first stored in the memory 112, is decoded by the image processing unit 113, and then is output to the display unit 107 via the display control unit 106. Alternatively, the data is output to an external display apparatus 150 via the output unit 108.

When the reproduction process is performed, the reproduction control unit 104 determines an image reproduction sequence or a display method. Specifically, for example, the reproduction control unit 104 performs an identification process to determine whether the data to be displayed is multi viewpoint images such as 3-dimensional images or single viewpoint images such as 2-dimensional images.

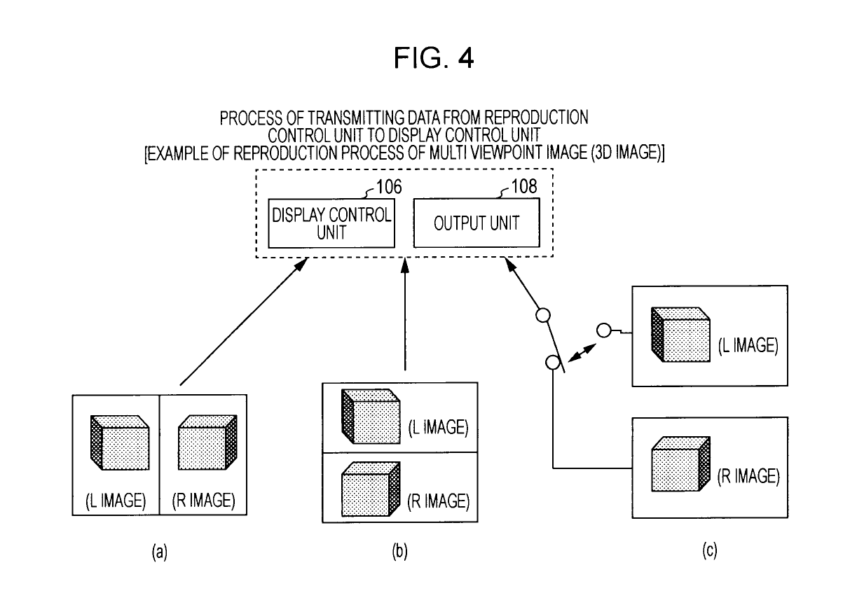

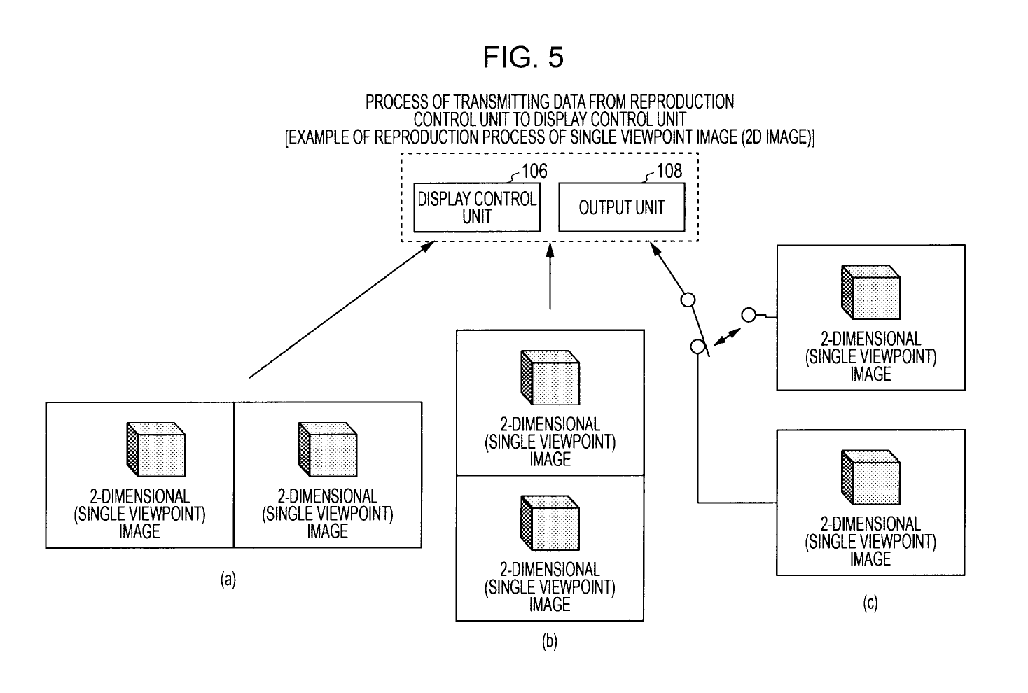

According to the identification result, the reproduction control unit 104 changes the image form to be output to the display control unit. A specific example of this process will be described below with reference to FIGS. 4 and 5.

The display control unit 105 outputs the images received from the reproduction control unit 104 to the display unit 107. Alternatively, the output unit 108 outputs the images received from the reproduction control unit 104 to the external display apparatus 150.

In the series of processes, not only the photographed image data but also data such as GUI data such as a menu used to display data to the user and successive images obtained from the lens are synthesized by the display control unit 106 and are output to the display unit 107 or the display apparatus 150 connected via the output unit 108.

### 2. EXEMPLARY STRUCTURE OF RECORDED DATA

Next, an exemplary recording configuration in which the data photographed by the imaging apparatus 100 shown in FIG. 1 is recorded in the recording medium 111 will be described with reference to FIG. 2.

As described above, the recording process is performed according to, for example, the DCF (Design rule for Camera File system) which is a standard of the recording method of the photographed data of a camera.

An exemplary directory structure corresponding to the DCF standard will be described with reference to FIG. 2. The DCF standard is a file system standard for realizing image mutual use via a recording medium between a digital still camera and a printer. The DCF standard describes a method of giving a file name or the configuration of a folder when an image is recorded in a recording medium based on Exif (Exchangeable image file format). Exif is a standard for adding image data and camera information to an image file and describes a format (file format) for recording the image file. In the DCF standard, the image file is recorded in a recording medium according to a directory structure.

FIG. 2 is a diagram illustrating an exemplary structure of a DCIM directory 200.

As shown in FIG. 2, in a typical DCF standard, a directory “DCIM” 201 is located directly under a root directory (ROOT). Image folders such as “101 AAAAA” 202 and “102 AAAAA” 203 are located under the directory “DCIM” 201. The name of the image folder has 8 characters. The first to third characters are a directory number from 100 to 999. The fourth to eighth characters are characters called free characters for only One-byte English upper case characters.

The image files are located under the image folder.

For example, image files 211 to 213 (AAAA000n.xxx) are located in the folder “101 AAAAA” 202.xxx indicates an extension.

The file name of the image file has 8 characters excluding the extension. The first to fourth characters are free characters for only One-byte English upper case characters. The fifth to eighth characters are file numbers from 0001 to 9999. The image files 211 to 213 are image files including the image data generated by the photographing control unit 102 (image content).

When the recorded image is the single viewpoint image such as a 2-dimensional image, “.JPG” is used as an extension of a sill image file indicating a JPEG (Joint Photographic Coding Experts Group) format.

When the recorded image is the multi viewpoint image such as a 3-dimensional image, “.MPO” is used as an extension of an image file indicating an MPO (Multi-Picture Format) format.

As shown in FIG. 2, the single viewpoint image such as a 2D image and the multi viewpoint image such as a 3D image can be stored together in a storage medium. Different extensions are set in the viewpoint images, respectively. For example, the reproduction control unit 104 can determine whether an image is a 2D image or a 3D image by analyzing the image based on the extension.

In the example shown in FIG. 2, the following image files and the following file set are located under the image folder 101 AAAAA, 202:

an image file [AAAA0001.JPG] which is the single viewpoint image (2D image) file 211;

an image file [AAAA0002.JPG]&[AAAA0002.MPO] which is a file set 212 of a single viewpoint image (2D image) file and a multi viewpoint image (3D image) file; and

an image file [AAAA0003.MPO] which is a multi viewpoint image (3D image) file 213.

The file set 212 of the single viewpoint image (2D image) file and the multi viewpoint image file such as a 3D image, that is, the image file [AAAA0002.JPG]&[AAAA0002.MPO] set is a file set which includes two files of which the names are same as each other and only extensions are different. The file set is a file in which the 2D image and the 3D image coexist. For example, when the file set is reproduced, the conversion between the 2D image and the 3D image has to necessarily occur.

As described above, when the recorded image is a single viewpoint image such as a 2-dimensional image, the recording process is performed in the JPEG (Joint Photographic Coding Experts Group) format. When the recorded image is a multi viewpoint image such as a 3-dimensional image, the recording process is performed in the MPO (Multi-Picture Format) format.

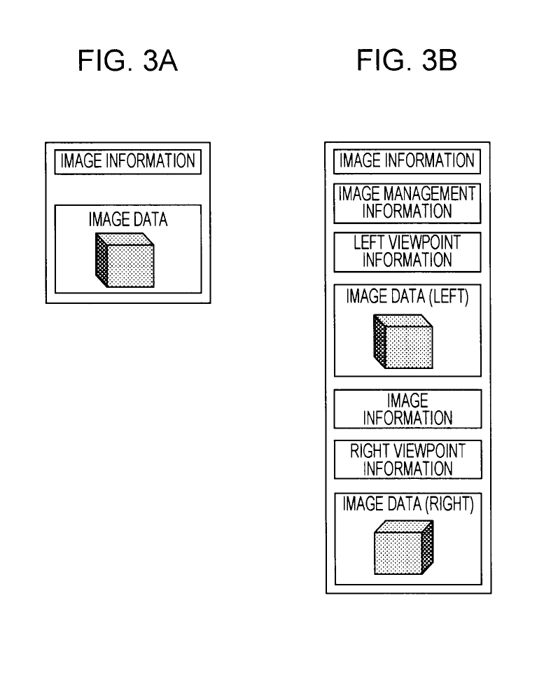

An exemplary file structure of each format will be described with reference to FIGS. 3A and 3B.

FIG. 3A is a diagram illustrating a file structure of the JPEG (Joint Photographic Coding Experts Group) format which is a recording file of the single viewpoint image such as a 2-dimensional image.

FIG. 3B is a diagram illustrating a file structure of the MPO (Multi-Picture Format) format which is a recording file of the multi viewpoint image such as a 3-dimensional image.

As shown in FIG. 3A, a JPEG file which is a recording file of the single viewpoint image such as a 2-dimensional image is a file having a structure including image information and image data.

Various kinds of management information used to manage the image data are recorded in the image information. For example, attribute information such as a date in which an image is generated (photographed), the size of the image, and a thumbnail image are recorded.

Image data is recorded in the image data.

On the other hand, as shown in FIG. 3B, an MPO file which is a recording file of the multi viewpoint image such as a 3-dimensional image includes data such as image information, image management information, left viewpoint information, image data (left), image information, right viewpoint information, and image data (right). The image data (left) is image data observed by the left eye when a 3-dimensional image display process is performed. The image data (right) is image data observed by the right eye when the 3-dimensional image display process is performed.

Various kinds of management information, such as an image number or image attribute, such as viewpoint information or representative image information, in a file, for managing the image data stored in the image information are recorded in the image management information. The viewpoint information is information indicating which viewpoint information is stored in the image file. The representative image information is information indicating a viewpoint corresponding to a representative image among viewpoints stored in the image file. In the example shown in FIG. 3B, information regarding left and right viewpoints as the viewpoints is stored. Therefore, “two viewpoints” are recorded in the viewpoint information. A “left viewpoint image” is stored in the representative image information in order to set the left viewpoint image between the left viewpoint and the right viewpoint as the representative image.

The image information is set to correspond to the image data (left) and the image data (right). Various kinds of management information, such as a date at which an image is generated (photographed), the size of the image, and information regarding a thumbnail image, used to manage each image data are recorded in the image information.

Information, such as a base-line length or an angle, regarding the location of each viewpoint is stored in the left viewpoint information and the right viewpoint information. Here, the base-line length is a distance between two viewpoints at photographing time of the corresponding image file, and is a value corresponding to the length between the two eyes of a person. The angle is an angle (angle centered on one point) specified by two lines formed between two viewpoints and a subject (one point) at the photographing time of the corresponding image file, and corresponds to an angle specified by two lines formed between the two eyes of a person and the subject (one point).

As described above, the image data corresponding to the left viewpoint and the image data corresponding to the right viewpoint are recorded in the image data (left) and the image data (right), respectively.

In the display process, for example, the two images are converted and displayed. Thus, a user wears shutter-type glasses operating in synchronization with the display conversion timing to view a left-eye image with the left eye and view a right-eye image with the right eye.

However, the method of displaying the 3-dimensional images is not limited to the configuration using the shutter-type glasses. The embodiment of the invention is not limited to the display method in terms of various methods.

### 3. IMAGE REPRODUCING PROCESS

Next, a reproduction process of reproducing the images stored in the recording medium 111 will be described below with reference to FIG. 4.

The reproduction process is performed such that a file designated by user is acquired from the recording medium 111 under the control of the reproduction control unit 104, a predetermined process is performed on the file acquired by the reproduction control unit 104, and the file is output to the display control unit 106, and the display process is performed by the display unit 107. Alternatively, when the display process is performed by the external display apparatus 150, the file is output to the external display apparatus 150 via the output unit 108 from the reproduction control unit 104.

The reproduction control unit 104 first selects a reproduction folder or a reproduction file according to designation information of a user and sequentially determines the reproduction according to the designation information of the user or preset default information. Specifically, for example, the reproduction sequence is determined according to the recording sequence or date sequence of the image files or by an arrangement unit described in database or the like. The image processing unit 113 performs a decoding process according to the determination sequence and supplies the result to the display control unit 106 or the output unit 108.

When this process is performed, the reproduction control unit 104 determines whether the reproduction image is the single viewpoint image such as a 2-dimensional image or the multi viewpoint image such as a 3-dimensional image, and performs another process according to the determined image.

Exemplary processing described below is exemplary processing when the display unit 107 or the display apparatus 150 is set in a display mode of the 3-dimensional images.

The process performed by the reproduction control unit 104 in this setting state will be described with reference to FIGS. 4 and 5.

FIG. 4 is a diagram illustrating exemplary processing when output images are the 3-dimensional images (multi viewpoint images).

FIG. 5 is a diagram illustrating exemplary processing when output images are the 2-dimensional images (single viewpoint images).

The reproduction control unit 104 performs the processing shown in FIG. 4, when the output images are the 3-dimensional images. The reproduction control unit 104 immediately changes the processing shown in FIG. 4 to the processing shown in FIG. 5, when the output images are changed from the 3-dimensional images to the 2-dimensional images. The same is applied reversely, the reproduction control unit 104 performs the process shown in FIG. 5, when the output images are the 2-dimensional images. The reproduction control unit 104 immediately changes the process shown in FIG. 5 to a process shown in FIG. 4, when the output images are changed from the 2-dimensional images to the 3-dimensional images. Moreover, whether the output images are the 2-dimensional images or the 3-dimensional images can be determined based on, for example, the extension set in the file.

First, the exemplary processing performed by the reproduction control unit 104 when the output images are the 3-dimensional images will be described with reference to FIG. 4. For example, when the image to be reproduced is the multi viewpoint image, the reproduction control unit 104 selects arbitrary image data as a left viewpoint image and performs a process of selecting a right viewpoint image with the base-line length or at the angle. For example, the selected process is performed based on the image management information or each of the viewpoint information described in the file.

In FIG. 4, exemplary processing of a plurality of different 3-dimensional images according to data transmission formats is shown.

As shown in FIG. 4, for example, the data transmission format of the 3-dimensional images includes:

(a) a side-by-side method;

(b) an over-and-under method; and

(c) a frame sequential method.

(a) The side-by-side method is a method of outputting the left-eye image (L image) and the right-eye image (R image) by dividing one image frame into the left-half portion and the right-half portion.

(b) The over-and-under method is a method of outputting left-eye image (L image) and the right-eye image (R image) by dividing one image frame into the upper-half portion and the lower-half portion.

(c) The frame sequential method is a method of alternately outputting the left-eye image (L image) and the right-eye image (R image) by setting individual frames for the left-eye and right-eye images.

The left-eye image (L image) and the right-eye image (R image) are applied in the display control unit or the display apparatus, and the 3-dimensional images are displayed according to each display method. The transmission format of the 3-dimensional images and the displaying method for the 3-dimensional images are independent from each other, and the display control unit of the subject apparatus or the display apparatus displays the images input according to various transmission formats to perform the display of the 3-dimensional images.

In the example shown in FIG. 4, when the output images are the 3-dimensional images, the reproduction control unit 104 draws the images on the memory of the image data corresponding to the image frame data according to the respective transmission formats ((a) to (c)).

The reproduction control unit 104 sets the image data corresponding to the frames shown in parts (a) to (c) of FIG. 4 as the transmission data according to the respective methods shown in parts (a) to (c) of FIG. 4, and outputs the image data to the display control unit 106 or the output unit 108.

In the case of (a) the side-by-side method, the left-eye image (L image) and the right-eye image (R image) are output respectively by dividing one image frame into the left-half portion and the right-half portion.

In the case of (b) the over-and-under method, the left-eye image (L image) and the right-eye image (R image) are output respectively by dividing one image frame into the upper-half portion and the lower-half portion.

In the case of (c) the frame sequential method, the left-eye image (L image) and the right-eye image (R image) are alternately output by setting the individual frames for the left-eye and right-eye images.

Each of the processes is the same as that of a general method of outputting 3-dimensional images.

The display control unit 108, to which the set 3-dimensional images are input, or the display apparatus 150, to which the set 3-dimensional images are input via the output unit, displays the input image according to a predetermined 3-dimensional image display method. For example, as the display process of displaying the images for the user wearing the above-described shutter-type glasses, the 3-dimensional images are displayed by setting the display process of alternately outputting the left-eye images (L images) and the right-eye images (R images).

Next, the exemplary processing performed by the reproduction control unit 104 when the output images are the 2-dimensional images will be described with reference to FIG. 5.

As in FIG. 4, in FIG. 5, exemplary processing of a plurality of different 3-dimensional images according to data transmission formats is shown.

That is, the exemplary output processing of the 2-dimensional images performed by the reproduction control unit 104 according to the following methods is shown:

(a) a side-by-side method;

(b) an over-and-under method; and

(c) a frame sequential method.

As shown in FIG. 5, the reproduction control unit 104 performs the following process according to each transmission format.

In the case of (a) the side-by-side method, the same 2-dimensional (single viewpoint) image is stored and output in both the left-half portion and the right-half portion of one image frame.

In the case of (b) the over-and-under method, the same 2-dimensional (single viewpoint) image is stored and output in both the upper-half portion and the lower-half portion of one image frame.

In the case of (c) the frame sequential method, the same 2-dimensional (single viewpoint) image is stored and output for each one pair of the storage frame for the left-eye image (L image) and the storage frame for the right-eye image (R image) in the transmission case of the 3-dimensional image.

The display control unit 108, to which the set 2-dimensional images (single viewpoint images) are input, or the display apparatus 150, to which the set 2-dimensional images are input via the output unit, displays the input 2-dimensional image by the same process as that of the 3-dimensional image. For example, in the display process of displaying the 3-dimensional images for the user wearing the above-described shutter-type glasses, the 3-dimensional images are displayed by setting the display process of alternately outputting the left-eye images (L images) and the right-eye images (R images).

Even when the 2-dimensional images (single viewpoint images) shown in FIG. 5 are input, the display control unit 108 or the display apparatus 150 to which the images are input via the output unit performs the same process without changing the process.

That is, the display control unit 108 or the display apparatus 150 performs the process of displaying the 2-dimensional images (single viewpoint images) instead of the process of displaying the left-eye images (L images) of the 3-dimensional images and displaying the same 2-dimensional images (single viewpoint images) instead of the process of displaying the left-eye images (L images).

In this case, for example, the user wearing the shutter-type glasses can view the same 2-dimensional images (single viewpoint images) with both the right and left eyes. Therefore, when a general planar image is observed, the same image can be observed.

By performing this process, it is not necessary for the display unit or the display apparatus to change the image output method. Therefore, time loss caused due to the change in the display form does not occur.

Even when the user wears the shutter-type glasses or the like for observing 3-dimensional images, it is not necessary for the user to take off the glasses, thereby reducing the burden on the user.

Thus, in a case where the display unit performs the display in the display mode of the multi viewpoint images, the reproduction control unit 104 of the image processing apparatus according to the embodiment of the invention generates the output data in which each viewpoint image forming the multi viewpoint image is developed at the development position of each viewpoint image defined according to the multi viewpoint image transmission format and outputs the output data to the display control unit or the like, when outputting the multi viewpoint images. The reproduction control unit 104 generates the output data in which the same single viewpoint image is developed at the development position of each viewpoint image defined according to the transmission format of the multi viewpoint images and outputs the output data to the display control unit or the like, when outputting the single viewpoint images.

Specifically, in the case where the 3-dimensional image transmission format is the side-by-side method, the reproduction control unit generates the output data in which the images corresponding to the left and right viewpoints are respectively developed at the left and right positions in one frame image and outputs the output data to the display control unit or the like, when the reproduction control unit outputs the 3-dimensional images. The reproduction control unit generates the output data in which the same 2-dimensional image is developed at the left and right positions in one frame image and outputs the output data to the display control unit or the like, when the reproduction control unit outputs the 2-dimensional images.

In the case where the 3-dimensional image transmission format is the over-and-under method, the reproduction control unit generates the output data in which the images corresponding to the left and right viewpoints are respectively developed at the upper and lower positions in one frame image and outputs the output data to the display control unit or the like, when the reproduction control unit outputs the 3-dimensional images. The reproduction control unit generates the output data in which the same 2-dimensional image is developed at the upper and lower positions in one frame image and outputs the output data to the display control unit or the like, when the reproduction control unit outputs the 2-dimensional images.

In a case where the 3-dimensional image transmission format is the frame sequential method, the reproduction control unit generates the output data in which images corresponding to left and right viewpoints are alternately developed for each frame, and outputs the output data to the display control unit or the like, when outputting the 3-dimensional images. The reproduction control unit generates the output data in which the same 2-dimensional image is developed for each two successive frames, and outputs the output data to the display control unit or the like, when reproduction control unit outputs the 2-dimensional images.

By the above processes, the multi viewpoint images and the single viewpoint images can smoothly be converted and displayed without performing the conversion process in the display unit.

### 4. DISPLAY CONTROL SEQUENCE OF IMAGE PROCESSING APPARATUS ACCORDING TO EMBODIMENT OF THE INVENTION

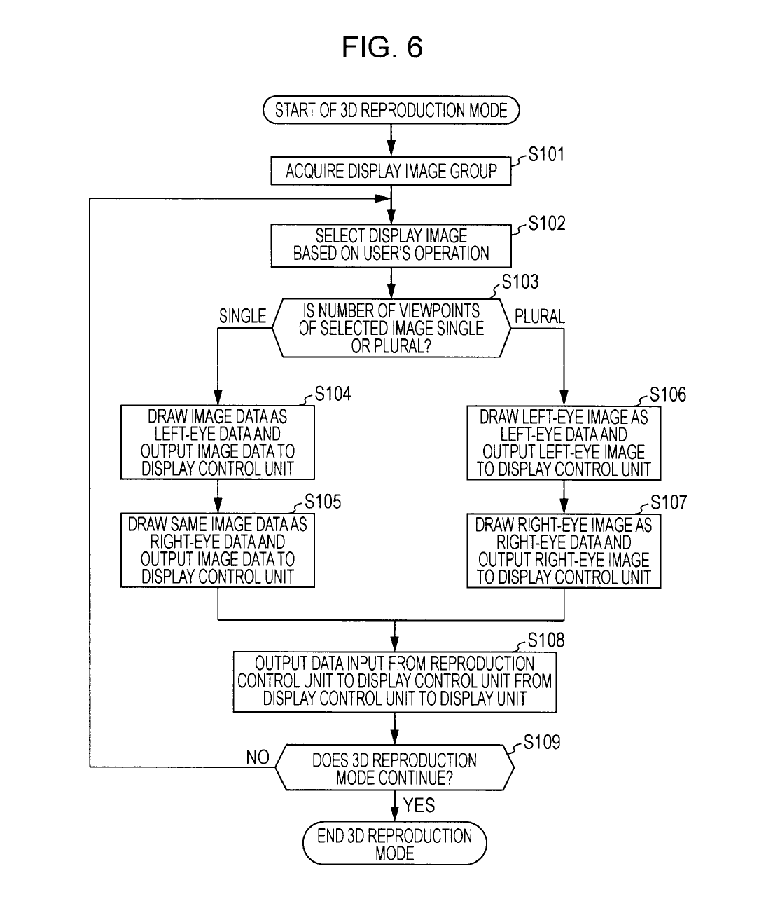

Next, the display control sequence of the image processing apparatus according to the embodiment of the invention will be described with reference to the flowchart shown in FIG. 6.

The flowchart shown in FIG. 6 is a flowchart for describing the processing sequence performed by the reproduction control unit so as to correspond to the process described above with reference to FIGS. 4 and 5 when the display unit is set in the 3-dimensional image display mode.

In step S101, the reproduction control unit 104 acquires an image file group recorded in the recording medium 111 and outputs, for example, a menu screen. Specifically, the title of the image file written in the display unit is displayed.

In step S102, an image designated for reproduction is selected based on user operation.

Next, in step S103, the reproduction control unit 104 determines whether the selected image to be reproduced is a 2-dimensional (single viewpoint) image or a multi viewpoint image such as a 3-dimensional image. This determination process can be performed based on, for example, the extension (JPG/MPO) of each file.

In step S103, when the reproduction control unit 104 determines that the selected image to be reproduced is a 2-dimensional (single viewpoint) image, the process proceeds to step S104. When the reproduction control unit 104 determines that the selected image to be reproduced is a multi viewpoint image such as a 3-dimensional image, the process proceeds to step S106.

When the selected image to be reproduced is a 2-dimensional (single viewpoint) image, the acquired one image data is drawn in a left-eye image transmission area in the 3-dimensional image transmission format and is output to the display control unit in step S104.

In step S105, the same image data is drawn in a right-eye image transmission area in the 3-dimensional image transmission format and is output to the display control unit.

This process is a process corresponding to the process described above with reference to FIG. 5.

On the other hand, when the selected image to be reproduced is a multi viewpoint image such as a 3-dimensional image, the acquired left-eye image is drawn in the left-eye image transmission area in the 3-dimensional image transmission format and is output to the display control unit in step S106.

Next, in step S107, the acquired right-eye image is drawn in the right-eye image transmission area in the 3-dimensional image transmission format and is output to the display control unit.

This process is a process corresponding to the process described above with reference to FIG. 4.

Next, in step S108, the data input from the reproduction control unit to the display control unit is output to the display unit by the display control unit. This process is performed according to the 3-dimensional image display method. When the input image is either the 2-dimensional image or the 3-dimensional image, the same process is performed.

In step S109, it is determined whether the 3-dimensional image display mode ends. When it is determined that the 3-dimensional image display mode does not end, the process returns to step S102 and the same process is repeated. When it is determined that the 3-dimensional image display mode ends in step S109, the process ends.

### 5. MODIFIED EXAMPLES

Next, the image processing apparatus according to other embodiments of the invention will be described.

In the above-described embodiment, an example of the imaging apparatus has hitherto been described as an example of the image processing apparatus. The invention is not limited to the imaging apparatus as long as the image processing apparatus according to the embodiment of the invention is an apparatus capable of outputting the images to the display unit of the subject apparatus or an external display apparatus connected via the output unit, as described above. For example, various apparatuses such as a PC, a TV, and a media player may be used.

The apparatus may include no storage unit storing the image data. For example, an apparatus inputting the image data via a communication cable or a network and performing the reproduction control process may be used.

Moreover, the image processing apparatus may have a database and a database processing unit therein and a data processing unit acquiring information from the database may be provided to determine the display form using the information acquired from the database.

In the above-described embodiment, the example where the display mode in the display unit is the 3D image display mode has hitherto been described. However, the display mode may be changed manually by user input.

In the above-described embodiment, the example where two-viewpoint images of the left-eye image and the right-eye image are used as an example of the multi viewpoint images has hitherto been described. However, when images are output to the display unit performing the multi viewpoint image display to display N-viewpoint data with three or more viewpoints, the reproduction control unit 104 performs a process of outputting each image by allowing each image of N viewpoints to correspond to the same single viewpoint image.

When the N-viewpoint image is asked from a control unit of the display unit and the obtainable multi viewpoint image is an image of viewpoints less than N, the reproduction control unit of the image processing apparatus may perform a process of copying a partial image of the image of the viewpoints less than N and outputting the image as the N-viewpoint image.

The specific embodiment of the invention has hitherto been described in detail. However, it is apparent to those who are skilled in the art that the modification and alternations of the embodiment may occur within the scope of the invention without departing from the gist of the invention. That is, since the invention is disclosed according to the embodiment, the invention should not be construed as limiting. The claims of the invention are referred to determine the scope of the invention.

The series of processes described in the specification may be executed by hardware, software, or the combined configuration thereof. When the processes are executed by software, a program recording the processing sequence may be installed and executed in a memory in a computer embedded in dedicated hardware or a program may be installed and executed in a general computer capable of various kinds of processes. For example, the program may be recorded in advance in a recording medium. As well as installing the program in a computer from the recording medium, the program may be received via a network such as a LAN (Local Area Network) or the Internet and may be installed in a recording medium such as a built-in hard disk.

The various kinds of processes described in the specification may be executed chronologically according to the description or may be executed in parallel or individually depending on the processing capacity of an apparatus executing the processes or as necessary. The system in the specification has a logical collective configuration of a plurality of apparatuses and is not limited to a case where the apparatuses with each configuration are included in the same chassis.

The present application contains subject matter related to that disclosed in Japanese Priority Patent Application JP 2010-077985 filed in the Japan Patent Office on Mar. 30, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a reproduction control unit inputting single viewpoint images and multi viewpoint images and generating output data to be output to a display unit,
wherein in a case where the display unit performs display in a multi viewpoint image display mode,
the reproduction control unit generates and outputs the output data in which each viewpoint image forming the multi viewpoint image is developed at a development position of each viewpoint image defined according to a multi viewpoint image transmission format when outputting the multi viewpoint images, and
the reproduction control unit generates and outputs the output data in which the same single viewpoint image is developed at the development position of each viewpoint image defined according to the multi viewpoint image transmission format when outputting the single viewpoint images.

2. The image processing apparatus according to claim 1,
wherein in a case where the display unit performs display in a 3-dimensional image display mode,
the reproduction control unit generates and outputs the output data in which the left and right viewpoint images are respectively developed at image development positions corresponding to left and right viewpoints defined according to the 3-dimensional image transmission format when outputting the 3-dimensional images, and
the reproduction control unit generates and outputs the output data in which the same 2-dimensional image is developed at the image development positions corresponding to left and right viewpoints defined according to the 3-dimensional image transmission format when outputting the 2-dimensional images.

3. The image processing apparatus according to claim 2,
wherein in a case where the 3-dimensional image transmission format is a side-by-side method,
the reproduction control unit generates and outputs the output data in which images corresponding to left and right viewpoints are respectively developed at left and right positions in one frame image when outputting the 3-dimensional images, and
the reproduction control unit generates and outputs the output data in which the same 2-dimensional image is developed at the left and right positions in one frame image when outputting the 2-dimensional images.

4. The image processing apparatus according to claim 2,
wherein in a case where the 3-dimensional image transmission format is an over-and-under method,
the reproduction control unit generates and outputs the output data in which images corresponding to left and right viewpoints are respectively developed at upper and lower positions in one frame image when outputting the 3-dimensional images, and
the reproduction control unit generates and outputs the output data in which the same 2-dimensional image is developed at the upper and lower positions in one frame image when outputting the 2-dimensional images.

5. The image processing apparatus according to claim 2,
wherein in a case where the 3-dimensional image transmission format is a frame sequential method,
the reproduction control unit generates and outputs the output data in which images corresponding to left and right viewpoints are alternately developed for each frame when outputting the 3-dimensional images, and
the reproduction control unit generates and outputs the output data in which the same 2-dimensional image is developed for each two successive frames when outputting the 2-dimensional images.

6. The image processing apparatus according to any one of claims 1 to 5,
wherein the reproduction control unit performs a process of determining whether an input image is the single viewpoint image or the multi viewpoint image through analysis based on an extension of each image file.

7. The image processing apparatus according to claim 1,
wherein in a case where an N-viewpoint image is asked from the display unit, when the obtainable multi viewpoint image is an image of viewpoints less than N, the reproduction control unit copies a partial image of the image with the viewpoints less than N and outputs the image as the N-viewpoint image.

8. An image processing method of performing image output control by an image processing apparatus, the image processing method comprising the step of:
generating output data to be output to a display unit by inputting single viewpoint images and multi viewpoint images by a reproduction control unit,
wherein in a case where the display unit performs display in a multi viewpoint image display mode,
the step of generating the output data executes a process of generating and outputting the output data in which each viewpoint image forming the multi viewpoint image is developed at a development position of each viewpoint image defined according to a multi viewpoint image transmission format when the multi viewpoint images are output, and
the step of generating the output data executes a process of generating and outputting the output data in which the same single viewpoint image is developed at the development position of each viewpoint image defined according to the multi viewpoint image transmission format when the single viewpoint images are output.

9. A program causing an image processing apparatus to execute image output control, the program comprising the step of:
generating output data to be output to a display unit by inputting single viewpoint images and multi viewpoint images by a reproduction control unit,
wherein in a case where the display unit performs display in a multi viewpoint image display mode,
the step of generating the output data executes a process of generating and outputting the output data in which each viewpoint image forming the multi viewpoint image is developed at a development position of each viewpoint image defined according to a multi viewpoint image transmission format when the multi viewpoint images are output, and
the step of generating the output data executes a process of generating and outputting the output data in which the same single viewpoint image is developed at the development position of each viewpoint image defined according to the multi viewpoint image transmission format when the single viewpoint images are output.
